(19) United States
(12) Patent Application Publication
(10) Pub. No.: US 2021/0224893 A1
(43) Pub. Date: Jul. 22, 2021

(54) EVENT TRIGGERED POLICIES

(71) Applicants: Andrew Jackson Garner, IV, State Road, NC (US); Benjamin W. Geertz, Milwaukie, OR (US); Ramanathan Ramanathan, Bellevue, WA (US); Andrew Guitarte, Pittsburg, CA (US); Oleg Pravdin, Redwood City, CA (US); Darrell L. Suen, San Ramon, CA (US); Carolyn J. Thomas, San Francisco, CA (US)

(72) Inventors: Andrew Jackson Garner, IV, State Road, NC (US); Benjamin W. Geertz, Milwaukie, OR (US); Ramanathan Ramanathan, Bellevue, WA (US); Andrew Guitarte, Pittsburg, CA (US); Oleg Pravdin, Redwood City, CA (US); Darrell L. Suen, San Ramon, CA (US); Carolyn J. Thomas, San Francisco, CA (US)

(73) Assignee: WELLS FARGO BANK, N.A., Charlotte, NC (US)

(21) Appl. No.: 14/634,139

(22) Filed: Feb. 27, 2015

(51) Int. Cl. G06Q 40/02

(52) U.S. Cl. CPC G06Q 40/02

(57) ABSTRACT

Systems, methods, and other embodiments associated with event triggered policies are described herein. According to one embodiment, a system for event triggered policies includes an analytics engine and an implementation logic. The analytics engine includes a trigger logic and a monitor logic. The trigger logic stores event definitions. An event definition corresponds to an event. The monitor logic monitors personal factors related to the event. The analytics engine is configured to determine whether the personal factors satisfy the event definition. The analytics engine also selects a policy from the policies based, at least in part, on the event definition. The implementation logic implements the selected policy.

### BACKGROUND

When a user suffers a crisis, he or she may not be able to monitor and manage their assets. For example, a medical emergency may leave a user incapacitated and unable to handle their finances (e.g., pay bills, execute financial documents, buy and sell investments, open and close accounts, transfer funds, order currency, etc.). In addition to medical emergencies, the user may suffer from a psychological disorder, emotional trauma, and so on that leave the user unable to perform the tasks they previously performed to maintain their assets.

The inability to maintain financial assets is compounded in crises because the user may not have the time or ability to make the necessary arrangements to grant someone else the authority to manage their assets. For example, banking regulations may require that documents be signed and notarized to give someone else the ability to alter account information. Unfortunately, the user may be no longer be able to sign the required documents, leaving the user's assets unmanaged and in disarray. Moreover, the user and their assets may be more vulnerable to fraud during a crisis.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

As discussed above, users may be unable to monitor and manage their assets in a crisis. The crisis may also prevent the user from transferring control of their assets to a third party. This can leave the user financially adrift. In this unstable situation, the user may be more vulnerable to fraud. To alleviate this hardship on users, examples of systems, methods, and other embodiments associated with event-triggered policies are described herein. For example, a financial institution may allow users to prearrange a conditional authorization of a third party in a policy. For example, a user may have a policy that grants access to specified financial assets to his or her spouse in the event that the user suffers a medical emergency.

In one embodiment, users can set policies authorizing a third party, such as a family member or financial institution, to manage his or her financial assets and execute actions based on the user's health condition, geolocation, and other personal factors. For example, the actions available to the third party may include acting with Power of Attorney (POA), executing a will, allowing a third party to manage certain portions of the user's account, blocking transaction, etc. To take advantage of these services, the user would specify event triggers under which a corresponding policy is enacted.

A policy corresponding to an event trigger is implemented when the event trigger occurs. In one embodiment, the user's health status, geo-location, and financial assets are monitored to determine whether the event trigger has occurred. The user's health status and geo-location may be monitored by various devices, such as wearable devices, various Internet of Things (IoT) senor technologies, home health monitoring devices, etc. When the conditions are detected that correlate to the event triggers defined by the user, the associated policy is triggered. For example, the policies may be executed to move funds, initiate accounts, close accounts, alter ownership, initiate notifications, deliver documentation, and so on.

Accordingly, examples of systems, methods, and other embodiments associated with event-triggered policies allow users to prearrange a conditional authorization of a third party. Personal factors, such as health status, geo-location, and financial assets of the user may be collected in real-time so that the personal factors of the user can be measured and analyzed as they are occurring. The personal factors can be evaluated based on the event triggers defined in the policies. The policies can thus be enacted when the personal factors meet the event triggers. Accordingly, an authentication and authorization mechanism is provided that authenticates the user, detects the user's condition, and authorizes third parties to act on behalf of the user. Thus, users are able to authorize and/or trigger third parties to act on his or her behalf even when the user is incapacitated, thereby limiting the user and financial institution's exposure to fraud.

The following description and drawings set forth certain illustrative aspects and implementations. These are indicative of but a few of the various ways in which one or more aspects may be employed. Other aspects, advantages, or novel features of the disclosure will become apparent from the following detailed description and figures.

### BRIEF DESCRIPTION OF THE DRAWINGS

The accompanying drawings, which are incorporated in and constitute a part of the specification, illustrate various systems, methods, and other embodiments of the disclosure. Illustrated element boundaries (e.g., boxes, groups of boxes, or other shapes) in the figures represent one example of the boundaries. In some examples one element may be designed as multiple elements or multiple elements may be designed as one element. In some examples, an element shown as an internal component of another element may be implemented as an external component and vice versa.

FIG. 1 illustrates one embodiment of a system associated with event triggered policies.

FIG. 2 illustrates one embodiment of a system associated with event triggered policies having a pattern logic.

FIG. 3 illustrates one embodiment of a system associated with event triggered policies having a staging logic.

FIG. 4 illustrates one embodiment of a system associated with event triggered policies having a notification logic.

FIG. 5 illustrates one embodiment of a method associated with event triggered policies.

FIG. 6 illustrates one embodiment of a method associated with event triggered policies having authentication.

FIG. 7 illustrates one embodiment of an example computer environment associated with event triggered policies.

### DETAILED DESCRIPTION

Embodiments or examples illustrated in the drawings are disclosed below using specific language. It will nevertheless be understood that the embodiments or examples are not intended to be limiting. Any alterations and modifications in the disclosed embodiments and any further applications of the principles disclosed in this document are contemplated as would normally occur to one of ordinary skill in the pertinent art. Described herein are examples of systems, methods, and other embodiments associated with event triggered policies.

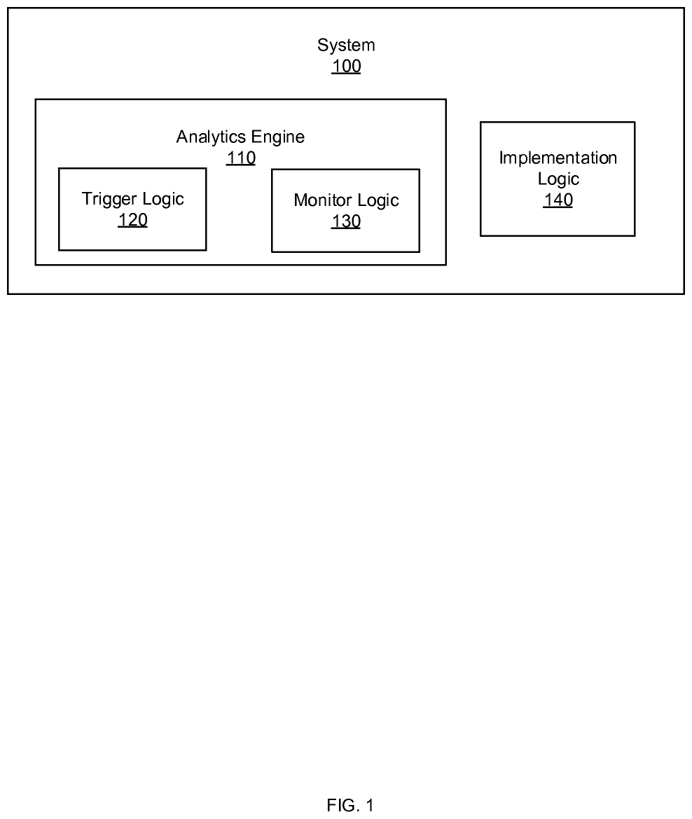

FIG. 1 is an illustration of an embodiment of a system 100 associated with event triggered policies. In one embodiment, the system 100 is employed by a financial institution to execute policies developed by customers without requiring customer intervention. For example, the system 100 may be employed to handle health, legal, and/or financial data in real-time or near real-time so as to enable policies to take effect as soon as possible rather than requiring a user intervention to make changes. Accordingly, the system 100 is employed with specialized components. For example, the system 100 includes an analytics engine 110 having a trigger logic 120 and a monitor logic 130. The system 100 further includes an implementation logic 140.

The analytics engine 110 is able to perform comparisons, calculations, and executables using data specified by and about a user. The data is aggregated by the trigger logic 120 and the monitor logic 130. For example, the trigger logic 120 stores policies defined by (or for) the user. As discussed above, a policy identifies documents and actions the user wishes to be implemented if a triggering event occurs. A policy may be an agreement specific to an identified financial asset. For example, a policy may define a conditional authorization of a third party to access a financial asset. As another example, the policy may be an existing legal document, such a contract, POA, medical POA, will, etc. The policy may also include one or more actions for implementing the policy. For example, an action may dictate that a document in the policy, such as a will, be sent to a specified third party (e.g., executrix).

The trigger logic 120 also stores event definitions that specify the conditions that constitute the triggering event occurring. For example, the user may have a policy that grants authorization to a third party for a specific account given a triggering event occurs, such as the user being hospitalized. An event definition may define a hospitalization as spending a predetermined number of hours in a geolocation associated with a hospital. Alternatively, the event definition may define a hospitalization as user's physician admitting the user to hospital.

In addition to policy information (e.g., policy, triggering event, prescribed actions), the analytics engine 110 uses monitored data aggregated by the monitor logic 130. The monitor logic 130 monitors a number of personal factors relevant to the triggering event. Consider the example given above, in which the user being hospitalized is the triggering event. The user may have family members in the hospital whom which the user visits, and thus, not wish to use continued presence at the hospital as the event definition of hospitalization. Instead, the user may select the physician admitting the user to hospital as event definition of hospitalization. Alternatively, the user may use multiple definitions for hospitalizations. Thus, the event trigger may have multiple event definitions that use multiple personal factors. Furthermore, a single even definition may include multiple personal factors such as both health data and geolocation data.

The monitor logic 130 monitors personal factors related to the user. For example, the monitor logic 130 may monitor the user's electronic patient records for a notification that the user has been admitted to the hospital. Accordingly, the monitor logic 130 monitors sources, such as entities (e.g., heath agency, doctor's office, hospital billing department, police blotter, etc.) that process data relevant to the event definition of the event trigger. In addition to monitoring data from entities, another source of data may include devices. The monitor logic 130 may monitor specific devices such as a heart monitor, wearable device, or implant. For example, user may define the triggering event as a specific health event, and thus identify specific health data to be monitored from a device. Suppose that the triggering event is a heart attack, the health data to be monitored may be cardiac data received from a heart monitor. Alternatively, a device may not be specified. Instead, the monitor logic 130 may access the Internet of Things (IoT) via a network connection to receive data from a sensor. For example, the monitor logic 130 may employ a network (WiFi, Local Area Network (LAN), Wide Area Local Network (WLAN), etc.) to monitor the communication between devices and by devices.

In one embodiment, the user may specify the event trigger more broadly. For example, the triggering event may be the user becoming incapacitated. The event definition of being incapacitated may include the user suffering a cardiac arrest. In addition to an event definition based on a health related personal factor, the user may wish to use an event definition based on a financial related personal factor. For example, suppose that the user has Alzheimer's disease and may not show any health consequences of being incapacitated. However, if a number of bills are reported as being unpaid, the user may wish the electronic billing be made available to a family member. Thus, the user may also use an event definition of incapacitation such that three or more missed mortgage payments constitute the event trigger having been met.

Accordingly, the monitored personal factors may also be more broadly defined. In addition to monitoring health data (e.g., brain wave activity, cardiac data, O₂ levels, etc.), the monitor logic 130 may also monitor financial data (e.g., payment history, credit reporting, etc.). Accordingly, the monitor logic 130 may receive data from a number of various sources. The monitor logic 130 may also request access to remotely stored data. For example, the user may track health data through a health-monitoring agency. The monitor logic 130 may interface with the health-monitoring agency to request access stored for the user. Likewise, the monitor logic 130 may periodically interface with financial institutions to receive the user's financial data. Thus, the monitor logic 130 may send requests or directly access different sources of data. Accordingly, in addition to passive monitoring, the monitor logic 130 may actively pursue data regarding personal factors associated with the user.

The analytics engine 110 uses the monitored data to determine if the triggering event has occurred. In one embodiment, the analytics engine 110 compares monitored data to the triggering event as defined by the user. Specifically, the analytics engine 110 correlates monitored data with an event definition. Suppose that the monitor logic 130 receives the mortgage payment data from a financial institution and the user misses three mortgage payments. The analytics engine 110 maps the mortgage payment data to the appropriate event definition. In the example given above, the mortgage payment data would be mapped to the event definition associated with missed mortgage payments.

Once the analytics engine 110 correlates the monitored data with event definitions, the analytics engine 110 determines if the triggering event has occurred. If the analytics engine 110 may compare the monitored data to the event definition. For example, the user has three missed mortgage payments, the analytics engine 110 compares the number of missed mortgage payments to number of missed mortgage payments specified in the event definition. Accordingly, the analytics engine 110 utilizes the trigger logic 120 and the monitor logic 130 to determine if the trigger event has occurred.

In response to the analytics engine 110 determining that the triggering event has occurred, the corresponding policy is provided to the implementation logic 140. The implementation logic 140 takes actions to implement the policy. The actions may depend on elements of the policy. For example, suppose that the policy grants authorization to a third party for a specific financial asset that is accessible using an online banking tool. The implementation logic 140 takes the actions necessary to grant authorization to the third party. For example, the implementation logic 140 may change the username and password combination associated with the financial asset from the user's to that of the third party.

In addition to user-defined policies, institutions managing the user's assets may have policies. For example, institutions may have policies to change the authorization for a specific asset if an event trigger associated with fraud is detected. Suppose that a financial institution determines that transactions conducted from devices not previously used by a user in geolocation not associated with the user are typically fraud related. An institution may set an event definition such that if a transaction is carried out on a user's account from an unknown device at a new location that a policy temporarily de-authorizing the user should be implemented.

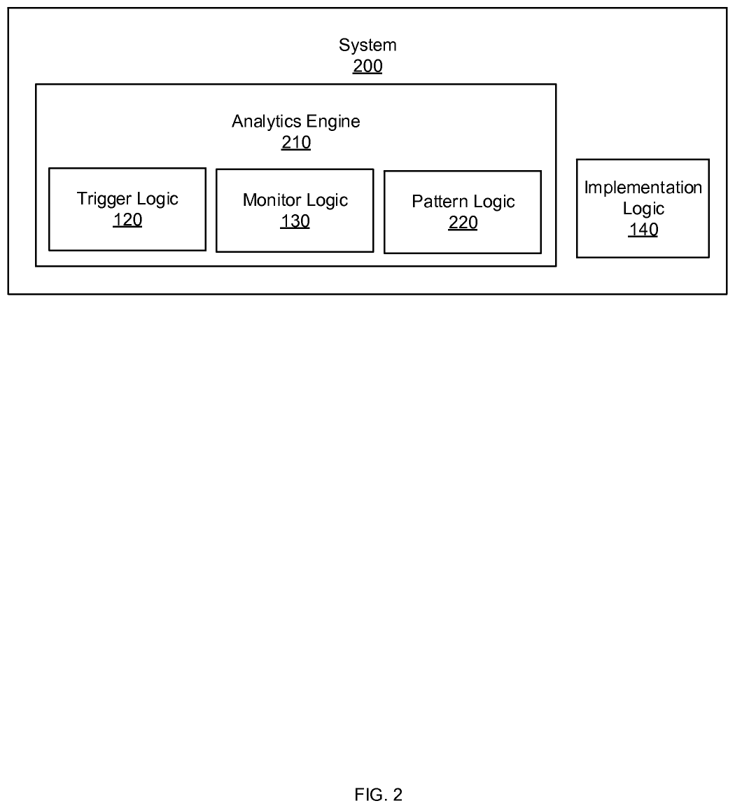

FIG. 2 illustrates one embodiment of a system 200 associated with event triggered policies having an analytics engine 210 with a pattern logic 220. The system 200 and analytics engine 210 operate in a similar manner as the system 100 and analytics engine 110, respectively, described above with respect to FIG. 1. Likewise, the trigger logic 120 and monitor logic 130 of the analytics engine 210 and the implementation logic 140 operate in a similar manner as described above with respect to FIG. 1.

As discussed above with respect to FIG. 1, the monitor logic 130 receives data from one or more sources. The pattern logic 220 identifies patterns in the monitored data associated with the personal factors. For example, the pattern logic 220 may identify that certain a bill is paid at the same time each month or within a certain range of days each month. The pattern logic 220 may also determine the typical amounts that a user spends in certain categories (e.g., housing, utilities, groceries, restaurants, electronics, clothing), the types of transactions typically performed, the geo-locations at which the user typically conducts business, and so on. While these examples refer to financial applications, the pattern logic 220 may also identify patterns in other types of monitored data, such as in health data. For example, the pattern logic may identify patterns in blood sugar, heart rate, and brain waves based on the time of day or geolocation. Accordingly, the pattern logic 220 is able to identify patterns in the monitored data.

The pattern logic 220 may identify patterns using pattern recognition. In one embodiment, the pattern logic 220 may use classification pattern recognition to identify patterns. In classification pattern recognition, the pattern logic 220 assigns instances of monitored data a value a corresponding to a set of classes. For example, the pattern logic 220 may assign a financial transaction a number of values that indicate metadata about the transaction. For example, the bill payment may be assigned values indicating the type of transaction (e.g., deposit, withdrawal, wire transfer, bill pay), mode of transaction (e.g., payment by check, online bill pay), bill payment, a dollar amount, time and date, and so on. The pattern logic 220 may then use the values to assess similarities and differences in the monitored data such that patterns emerge.

Again, while these example values refer to financial applications, the pattern logic 220 may also assign values to other types of monitored data. Furthermore, while classification is described as one embodiment of pattern recognition, alternative embodiment may use other methods of pattern recognition, alone or in combination. For example, the pattern logic 220 may use clustering ensemble learning, sequenced labeling, and so on.

Once the patterns are established, the pattern logic 220 identifies anomalous monitored data. For example, suppose that a user has a five year history with a financial institution and has never made a wire transfer. If the user suddenly starts conducting wire transfers, the pattern logic 220 identifies the transactions as anomalous given the user's previous patterns of behavior. The analytics engine 210 may use the data to determine that event trigger is met. For example, an event definition may be defined as a large transaction not previously identified in a pattern. Accordingly, event triggers may be patterned related. For example, a user may wish to have a policy implemented if the pattern of behavior related to a certain account changes.

Suppose that a user is a guardian of a junior individual and both the user and the junior individual are signatories on a joint account. As the guardian, the user may wish the junior individual to have a certain amount of autonomy to use financial assets. However, the user may also wish to remove the junior individual from the joint account if the junior individual begins acting out of character. For example, the pattern logic 220 may identify a pattern of on-time bill payments made by the junior individual. The user may define an event definition based on more broadly on an identified pattern rather that a specific event. For example, the user may approve of the junior individual's activity, and therefore define the event definition as a deviation from the identified pattern. Accordingly, if the pattern logic 220 identifies anomalous activity, that information is used by the analytics engine 210 to identify a corresponding policy and provide that policy to the implementation logic 140.

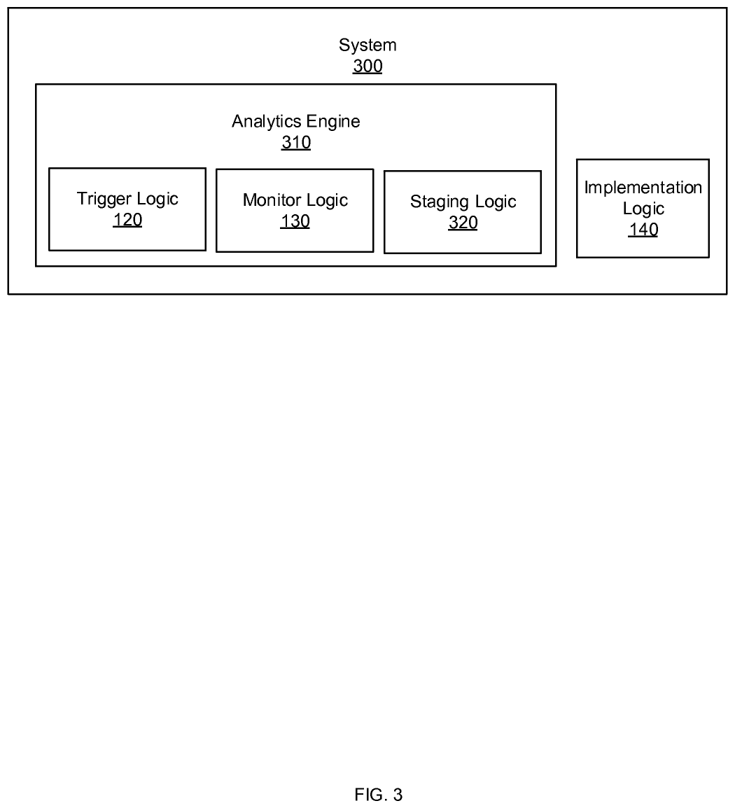

FIG. 3 illustrates one embodiment of a system 300 associated with event triggered policies having an analytics engine 310 with a staging logic 320. The system 300 and analytics engine 310 operate in a similar manner as the system 100 and analytics engine 110, respectively, described above with respect to FIG. 1. Likewise, the trigger logic 120 and monitor logic 130 of the analytics engine 310 and the implementation logic 140 operate in a similar manner as described above with respect to FIG. 1.

A policy may have a number of stages. The staging logic 310 manages policies that have multiple stages. The stages may be associated with the well-being of the user. In one example, the user may define granting access and control to different parties based on different event triggers. In one embodiment, a user may define a policy with two stages. In the first stage, the user may grant access to a close relative that is out of state in the event that the user is conscious but hospitalized. In the second stage, the user may grant access to a more distant relative that resides in the same state in the event that the user in unconscious and hospitalized. Accordingly, policies and stages give the user various options for granting access.

Once the analytics engine 310 determines that event trigger has occurred and identified a corresponding policy. The staging logic 320 analyses the event definition to determine a stage of the policy should be implemented based on the monitored data. The staging logic 320 is then able to select the appropriate stage and provide the appropriate stage to the analytics engine 310. The analytics engine 310 then provides the policy with the selected stage to the implementation logic 140, as discussed in previous embodiments.

In one embodiment, a stage of a policy may revoke an implemented policy. As in the previous example, consider that in the first stage the user may grant access to a close relative that is out of state in the event that the user is conscious but hospitalized. In the second stage, the user may grant access to a more distant relative that resides in the same state in the event that the user in unconscious and hospitalized. The policy may also include a third stage to restore access to the user and revoke access from a relative when the user is released from the hospital.

For example, suppose that based on previously monitored data, that the first stage of the policy was implemented by the implementation logic 140. The monitor logic 130 continues to monitor data related to personal factors. Consider that the monitor logic 130 receives a hospital release form or that the geo-location of the user changes to be outside of the hospital. The information would relate to the policy that is already in place, accordingly, the analytics engine 310 would not implement a new policy. Instead, the staging logic 320 would select a different stage of the implemented policy.

For example, as discussed above the third stage of the policy restores access to the user and revokes access from a relative when the user is released from the hospital. When the personal factors meet the event definition of the third stage, the selected stage is provided to the analytics engine 310. The analytics engine 310 may then provide the policy with the selected stage to the implementation logic 140. Accordingly, the selected stage would be implemented by the implementation logic 140 to restore access to the user and revoke access from the close relative. In this manner, the staging logic 320 may facilitate restoration and revocation of authorization.

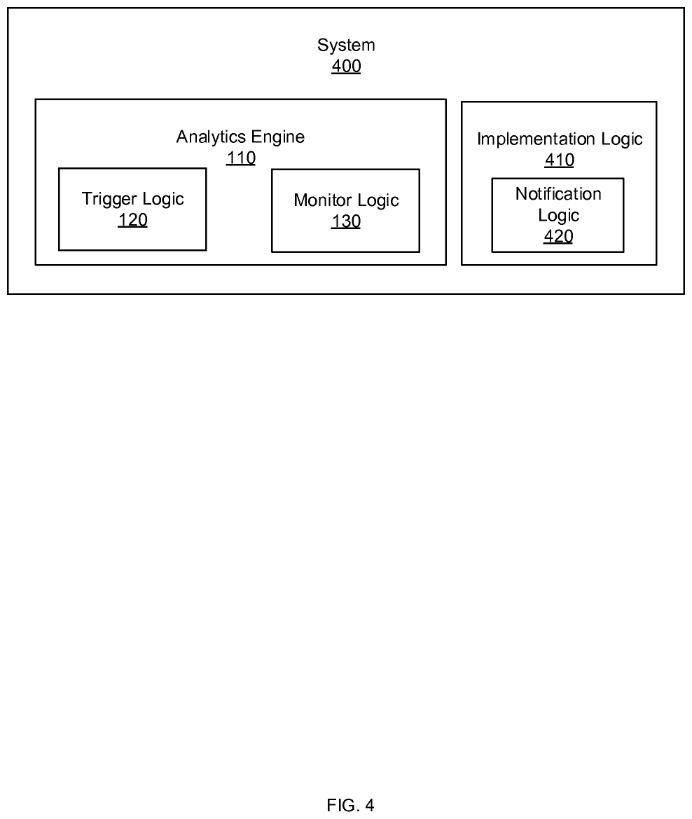

FIG. 4 illustrates one embodiment of a system 400 associated with event triggered policies having an implementation logic 410 with a notification logic 420. The system 400 operates in a similar manner as the system 100 described above with respect to FIG. 1. Specifically, the analytics engine 110, the trigger logic 120, and the monitor logic 130 operate in a similar manner as described above with respect to FIG. 1. Likewise, the implementation logic 410 operates in a similar manner as the implementation logic 140 described above with respect to FIG. 1.

A policy may include an action to send a message to an actor such as a user, third party, institution, and so on. The message may be an email, voicemail, short message service (SMS) message, post on a social media account, or other form of contact. The policy may indicate contact information for the actor indicated in the policy. The notification logic 420 may then access the policy for the contact information. For example, the policy may include telephone numbers to which the notification logic 420 may use to send an SMS message. Alternatively, the notification logic 420 may retrieve contact information. For example, consider that a policy is related to an account of a user. The notification logic 420 may contact the financial institution to request contact information for the user.

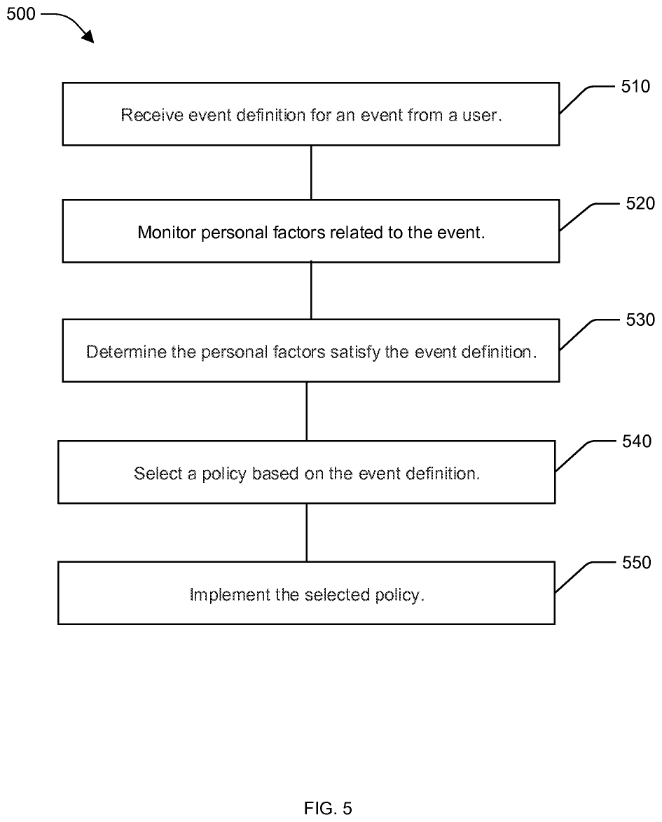

FIG. 5 illustrates one embodiment of a method 500 associated with event triggered policies. At 510, an event definition for an event is received from a user. At 520, personal factors. The personal factors are associated with a user and are related to the event are monitored. At 530, it is determined whether the personal factors satisfy the event definition. For example, as discussed above, the event may be a heart attack. Accordingly, a heart monitor may monitor personal factors such as heart rate. Suppose that the event definition defines cardiac arrest as a sudden stop in heartbeat lasting at least 5 seconds. The heart rate data is monitored to determine if the event definition is met.

At 540, a policy is selected from a set of policies based, at least in part, on the event definition. For example, a policy may designate an individual that the user wishes to conduct the use user's financial affairs. The policy may be linked to the event definition. For example, a policy may be stored in a table and be mapped to a number of event definitions. In another embodiment, the event definition may specify a particular policy to be selected.

At 550, the selected policy is implemented. The policy defines specific actions to take place on behalf of the user. In one embodiment, the policy identifies a third party to be authorized. Accordingly, the third party may access the user's asset or make decisions for the user. The policies may not grant the third party immediate access. Instead, the third party may receive a notification that the user will be authorized to act on the user's behalf if the user completes authorization. For example, the third party may have to register with a username and password. Accordingly, implementing the policy may not grant a third party immediate access but rather facilitate the third party's ability to become authorized.

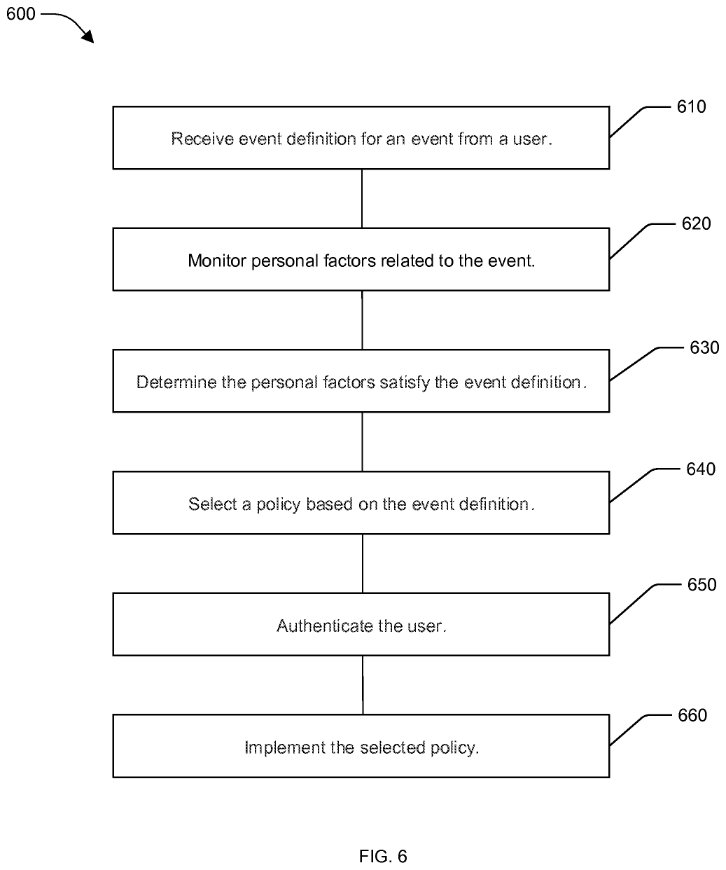

FIG. 6 illustrates one embodiment of a method 600 associated with event triggered policies having authentication. Steps 510, 520, 530, 540, and 550 of method 500 correspond to steps 610, 620, 630, 640, and 660 of method 600, respectively. Accordingly, steps 610, 620, 630, 640, and 660 operate in a similar manner as steps 510, 520, 530, 540, and 550 as described with respect to FIG. 5.

At 610, an event definition for an event is received from a user. At 620, personal factors of the user that are related to the event are monitored. At 630, it is determined whether the personal factors satisfy the event definition. At 640, a policy from a set of policies based, at least in part, on the event definition.

At 650, the user is authenticated to ensure that the user is who he or she purports to be before the policy is implemented. In one embodiment, the user may be authenticated based on the monitored personal factors. For example, personal factors may include health data such as biometrics. Accordingly, the biometrics may be used to authenticate the user's identity. In another embodiment, authentication may be based on other sources of data, such as patterns of user behavior. Authentication may require user intervention. For example, a user may be asked to authenticate his or her identity using security information, such a pin code. At 660, the policy is implemented in response to the user being authenticated.

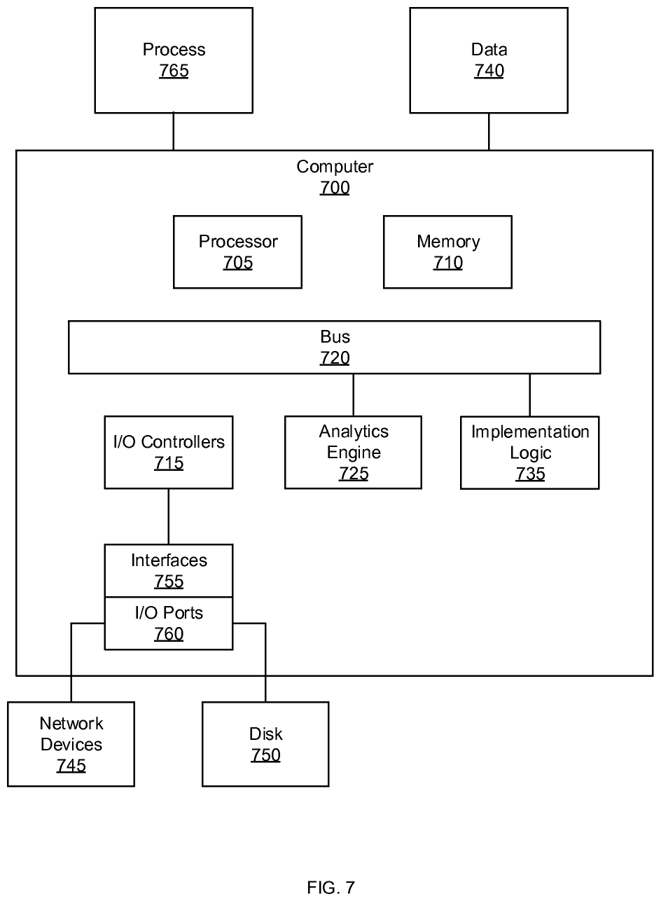

FIG. 7 illustrates one embodiment of an example computer environment associated with event triggered policies. The computer environment in which the systems and methods described herein, and equivalents, may operate may include a computer 700. The computer includes a processor 705, a memory 710, and input/output (I/O) ports 715 operably connected by a bus 720. In one example, the computer 700 may include an analytics engine 725 and an implementation logic 735. The analytics engine 725 may have specialized components for storing event definitions for an event and monitoring personal factors related to the event. The analytics engine 725 is configured to store a set of policies. The analytics engine 725 also determines that the personal factors satisfy an event definition. The analytics engine 725 then selects a policy from the policies based, at least in part, on the event definition. The implementation logic 735 is configured to implement the selected policy.

In different examples, the analytics engine 725 and the implementation logic 735 may be implemented in hardware, a non-transitory computer-readable medium with stored instructions, firmware, and/or combinations thereof. While the analytics engine 725 and the implementation logic 735 are illustrated as hardware components attached to the bus 720, it is to be appreciated that in one example, the analytics engine 725 and the implementation logic 735 may be implemented in the processor 705.

In one embodiment, the analytics engine 725 is a means (e.g., hardware, non-transitory computer-readable medium, firmware) for determining that the personal factors satisfy the event definition. The analytics engine is further a means (e.g., hardware, non-transitory computer-readable medium, firmware) for selecting a policy from the policies based, at least in part, on the event definition. The implementation logic 735 is a means (e.g., hardware, non-transitory computer-readable medium, firmware) for implementing the selected policy. The means may be implemented, for example, as an application specific integrated circuit (ASIC) programmed to facilitate data editing in a web-based interactive web response system. The means may also be implemented as stored computer executable instructions that are presented to computer 700 as data 740 that are temporarily stored in memory 710 and then executed by processor 705.

Generally describing an example configuration of the computer 700, the processor 705 may be a variety of various processors including dual microprocessor and other multi-processor architectures. The memory 710 may include volatile memory and/or non-volatile memory. Non-volatile memory may include, for example, ROM, PROM, and so on. Volatile memory may include, for example, RAM, SRAM, DRAM, and so on.

Network device 745 and a disk 770 may be operably connected to the computer 700 via, for example, an I/O interfaces (e.g., card, device) 755 and an I/O ports 760. The disk 745 may be, for example, a magnetic disk drive, a solid state disk drive, a floppy disk drive, a tape drive, a Zip drive, a flash memory card, a memory stick, and so on. Furthermore, the disk 745 may be a CD-ROM drive, a CD-R drive, a CD-RW drive, a DVD ROM, and so on. The memory 710 can store data 740 and/or a process 765, for example. The disk 750 and/or the memory 710 can store an operating system that controls and allocates resources of the computer 700.

The bus 720 may be a single internal bus interconnect architecture and/or other bus or mesh architectures. While a single bus is illustrated, it is to be appreciated that the computer 700 may communicate with various devices, logics, and peripherals using other busses (e.g., PCIE, 1394, USB, Ethernet). The bus 720 can be types including, for example, a memory bus, a memory controller, a peripheral bus, an external bus, a crossbar switch, and/or a local bus.

The computer 700 may interact with I/O devices via the I/O interfaces 755 and the I/O ports 760. Input/output devices may be, for example, a keyboard, a microphone, a pointing and selection device, cameras, video cards, displays, the network devices 745, the disk 750, and so on. The I/O ports 760 may include, for example, serial ports, parallel ports, and USB ports.

The computer 700 can operate in a network environment and thus may be connected to the network devices 745 via the I/O interfaces 755, and/or the I/O ports 760. Through the network devices 745, the computer 700 may interact with a network. Through the network, the computer 700 may be logically connected to remote computers. Networks with which the computer 700 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the method.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer storage medium”, as used herein, is a non-transitory medium that stores instructions and/or data. A computer storage medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer storage medium may include, but are not limited to, a computer-readable medium, a floppy disk, a flexible disk, a hard disk, a magnetic tape, other magnetic medium, an ASIC, a CD, other optical medium, a RAM, a ROM, a memory chip or card, a memory stick, and other media that can store instructions and/or data. Computer storage medium described herein are limited to statutory subject matter under 35 U.S.C § 101.

“Logic”, as used herein, includes a computer or electrical hardware component(s), firmware, a non-transitory computer storage medium that stores instructions, and/or combinations of these components configured to perform a function(s) or an action(s), and/or to cause a function or action from another logic, method, and/or system. Logic may include a microprocessor controlled by an algorithm to perform one or more of the disclosed functions/methods, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic component. Similarly, where a single logic component is described, it may be possible to distribute that single logic component between multiple physical logic components. In some embodiments, one or more of the components and functions described herein are implemented using one or more of the logic components. Logic as described herein is limited to statutory subject matter under 35 U.S.C § 101.

While for purposes of simplicity of explanation, illustrated methodologies are shown and described as a series of blocks. The methodologies are not limited by the order of the blocks as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks. The methods described herein is limited to statutory subject matter under 35 U.S.C § 101.

To the extent that the term “includes” or “including” is employed in the detailed description or the claims, it is intended to be inclusive in a manner similar to the term “comprising” as that term is interpreted when employed as a transitional word in a claim.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims, which satisfy the statutory subject matter requirements of 35 U.S.C. § 101.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

1. A system for event triggered policies, the system comprising:
an analytics engine configured to store policies, the analytics engine being a component specialized for triggering a subset of the policies without user intervention, the analytics engine being operative to perform comparisons, calculations, and executables using data specified by and about a user, the analytics engine having:
at least one hardware processor;
a trigger logic configured to store at east one event definition, wherein an event definition corresponds to an event; and
a monitor logic configured to monitor personal factors related to the event,
wherein the monitor logic interfaces with a health-monitoring agency to request access stored for the user, the monitor logic accesses the internet of thin s (IoT) via a network connection to receive user geo-location from an IoT wearable sensor, and the monitor logic periodically interfaces with financial institutions to receive the financial data of a user, wherein the analytics engine is further configured to (i) determine the personal factors satisfy the event definition, and (ii) select a policy from the policies based, at least in part, on the event definition; and
an implementation logic configured to implement the selected policy, wherein a single event definition may include multiple personal factors such as both health data and geolocation data.

2. The system for event triggered policies of claim 1, wherein the selected policy authorizes a third party to act on behalf of a user.

3. The system for event triggered policies of claim 1, further comprising:
a pattern logic configured to identify patterns in the monitored personal factors and anomalous data in the identified patterns;
wherein the analytics engine is configured to determine if the anomalous data satisfies the event definition.

4. The system for event triggered policies of claim 3, wherein the anomalous data is indicative of a fraud, wherein the policy is a fraud detection policy set by a financial institution, and wherein the institution, as part of its policy, changes the authorization required for a specific asset if an event trigger associated with fraud is detected.

5. The system for event triggered policies of claim 1, further comprising:
a staging logic configured to:
manage policies that have multiple stages;
analyze the event definition to determine a stage of the policy should be implemented based, at least in part, on the monitored data;
select the appropriate stage; and
provide the appropriate stage to the analytics engine.

6. The system for event triggered policies of claim 1, wherein the implementation logic further comprises a notification logic configured to send notifications when the implementation logic implements the selected policy.

7. The system for event triggered policies of claim 6, wherein one of the sent notifications is a short message service message to be sent to a third party.

8. A non-transitory computer-readable medium storing computer-executable instructions that when executed by a computer cause the computer to perform a method, the method comprising:
receiving an event definition for an event,
monitoring personal factors of a user related to the event, including monitoring health status and geo-location of the user via internet of things wearable devices;
determining the personal factors satisfy the event definition;
selecting a policy from a set of policies based, at least in part, on the event definition;
implementing the selected policy, wherein implementing the policy comprises at least authorizing a third party to act on behalf of the user, in accordance with a general power of attorney;
managing policies that have multiple stages;
analyzing the event definition to determine a stage of the policy should be implemented based, at least in part, on the monitored data;
selecting the appropriate stage; and
providing the appropriate stage to an analytics engine,
wherein in latter stages authority previously granted to a third party to allow the third party to act on behalf of the user may be revoked.

9. The method of claim 8, wherein the event is associated with the physical health of the user, and the personal factors comprise health data of the user.

10. The method of claim 8, wherein the policy indicates an asset of the user, and wherein authorizing the third party gives the third party access to the asset.

11. The method of claim 8, further comprising:
identifying patterns in the monitored personal factors;
identifying anomalous data in the identified patterns; and
determining if the anomalous data satisfies the event definition.

12. (canceled)

13. The method of claim 8, wherein implementing the selected policy further comprises sending a notification to the user.

14. The method of claim 8, wherein implementing the selected policy further comprises sending a notification to the third party.

15. A method, the method comprising:
receiving at least one event definition for at least one event;
monitoring personal factors of a user related to the one or more events, including the monitoring of the health and two-location status of the user via internet of things wearable devices;
authenticating the user based, at least in part, on the monitored personal factors;
determining the personal factors satisfy the event definitions;
selecting a policy, wherein the policy is stored in a table and mapped to multiple event definitions; and
implementing the selected policy, wherein implementing the policy comprises authorizing a third party to act on behalf of the user, wherein the policy indicates an asset of the user, and wherein authorizing the third party gives the third party access to the asset, and wherein the access granted to the third party is not granted immediately.

16. The method of claim 15, wherein the event is associated with the physical health of the user, and the personal factors comprise health data of the user.

17. (canceled)

18. The method of claim 15, further comprising:
identifying patterns in the monitored personal factors;
identifying anomalous data in the identified patterns; and
determining if the anomalous data satisfies the event definition.

19. The method of claim 15, wherein implementing the selected policy further comprises sending a notification to the user.

20. The method of claim 15, wherein implementing the selected policy further comprises sending a notification to the third party.

21. The method of claim 15, wherein biometrics are used to authenticate the identity of the user.

22. The system for event triggered policies of claim 3, wherein the pattern logic is further operative to assign a financial transaction a number of values that indicate metadata about the transaction.
